(19) United States
(12) Patent Application Publication
(10) Pub. No.: US 2005/0268753 A1
(43) Pub. Date: Dec. 8, 2005

(54) Hand tool having an adjustable head with joint lock mechanism

(75) Inventor: Yu-Cheng Lin, Taichung City (TW)

Correspondence Address: Ladas & Parry, 26 West 61st Street, New York, NY, 10023, US

(73) Assignee: LEA WAY HAND TOOL CORPORATION

(21) Appl. No.: 11/018,150

(22) Filed: Dec. 21, 2004

(30) Foreign Application Priority Data
Jun. 2, 2004 (TW) 093208736

(51) Int. Cl. B25B 23/16

(52) U.S. Cl. 81/177.9

(57) ABSTRACT

A hand tool having an adjustable head with joint lock mechanism, comprising a head having a rear end and a handle having a front end pivotally coupled to the rear end of the head, characterised in that: the joint lock mechanism is disposed between the rear end of the head and the front end of the handle, and the joint lock mechanism comprises a first engaging device, a second engaging device, a pull button and a first elastic device. The first engaging device is disposed at the rear end of the head. The handle has a first aperture longitudinally extending at the front end thereof to receive the second engaging device, and has a second aperture formed perpendicularly intersecting the first aperture to receive the pull button. The pull button has a knob portion and an engaging portion beneath the knob portion and the engaging portion extends along the second aperture and engages the second engaging device. The first elastic device is received in the first aperture and abuts against the second engaging device with a forward force such that the front end of the second engaging device is pushed to engage the first engaging device.

### BACKGROUND OF THE INVENTION

1. Field of the Invention

The present invention relates to a hand tool having an adjustable head with joint lock mechanism, especially a hand tool with a head of adjustable angles and easier, more secured positioning. The present application claims priority based on ROC (Taiwan) Patent Application No. 093208736.

2. Description of the Related Art

Conventional hand tools with an adjustable head, for example, as disclosed in TW421111, corresponding to U.S. Pat. No. 6,295,898, and TW488349, comprise a head and a handle. The head has a convex portion which can be pivotally coupled to a concave portion of the handle. Teeth are disposed along the surface of the convex portion to engage a ball received in an aperture formed in an inner wall of the concave portion. A stop member is disposed between the head and the handle. A positioning portion is formed at a rear side of the stop member and is coupled to a front end of the handle. A toothed portion formed at a front side of the stop member is engageable with a toothed surface portion formed along the surface of one side of the convex portion. When the stop member is slid to a predetermined position, the adjustment and positioning of the head at a certain angle can be more securely and conveniently done. However, with this kind of wrench, the ball is of a circular shape and cannot ensure secured engagement, and similar to the configuration of a ball and a toothed portion of a convex portion, the toothed portion of the stop member and the toothed surface portion of the handle may be worn out after use for a long period, which can therefore cause inconvenience when in use and reduce the life time of the hand tool.

TW478444 has disclosed a wrench wherein a through hole is formed in the centre of a shaft and threads are formed on a wall of the through hole at a bottom of the shaft to receive an operation rod. A handle is mounted at a bottom end of the operation rod and rotates synchronously with the operation rod. A concave portion formed at a top end of the shaft is coupled to a head and secured by a screw. A retainer is received in the through hole of the shaft with its one end coupled to the top end of the operation rod and an arc shaped concave portion formed on the other end. A rotatable worm supported by a retainer is disposed in the concave portion of the shaft and a groove fitted with a clip is formed at a protrusion of the worm at one end. A worm gear is disposed at an extension end of the head and engages the worm. The other end of the worm is coupled to a pivotal block and a crane to actuate the worm gear and the worm such that the head can be rotated at any angle. Again, with this configuration, the worm and the worm gear may be worn out after use for a long period, which causes the local structure to be loose and unable to be positioned properly. In addition, it is likely that the clip, operation rod, the retainer or the pivotal block and the crane might become loose and make the wrench un-useable.

From the above, it is necessary for the industry to provide a hand tool having an adjustable head with joint lock mechanism, which offers convenient and secured angle adjustment and positioning and can overcome the defects mentioned in the prior art.

### SUMMARY OF THE INVENTION

It is an object of the present invention to provide a hand tool having an adjustable head with joint lock mechanism, easier and more secured positioning.

According to the present invention, a hand tool having an adjustable head with joint lock mechanism comprises a head having a rear end and a handle having a front end pivotally coupled to the rear end of the head, characterised in that: the joint lock mechanism is disposed between the rear end of the head and the front end of the handle, and the joint lock mechanism further comprises a first engaging device, a second engaging device, a pull button and a first elastic device. The first engaging device is disposed at the rear end of the head. The handle has a first aperture longitudinally extending at the front end thereof to receive the second engaging device, and has a second aperture formed perpendicularly intersecting the first aperture to receive the pull button. The pull button has a knob portion and an engaging portion beneath the knob portion and the engaging portion extends along the second aperture and engages the second engaging device. The first elastic device is received in the first aperture and abuts against the second engaging device with a forward force such that the front end of the second engaging device is pushed to engage the first engaging device.

### DESCRIPTION OF THE DRAWINGS

Other objects, advantages and novel features of the present invention will be drawn from the following detailed description of preferred embodiments of the present invention with the accompanying drawings, in which:

FIG. 1 illustrates an exploded view of a handle tool having an adjustable head with joint lock mechanism according to the present invention;

FIG. 2 illustrates a locally enlarged plan view thereof;

FIG. 3 illustrates a sectional view thereof along line A-A in FIG. 2 showing a pull button at a locked state;

FIG. 4 illustrates a sectional view thereof along line A-A in FIG. 2 showing the pull button at an unlocked state;

FIG. 5 illustrates a locally enlarged side view thereof;

FIG. 6 illustrates a sectional view thereof along line B-B in FIG. 5 showing the pull button at a locked state;

FIG. 7 illustrates a sectional view thereof along line B-B in FIG. 5 showing the pull button at an unlocked state;

FIG. 8 illustrates a sectional view thereof along line A-A in FIG. 2 showing the head inclining 0° with respect to a handle;

FIG. 9 illustrates a sectional view thereof along line A-A in FIG. 2 showing the head inclining 11.25° with respect to the handle;

FIG. 10 illustrates a sectional view thereof along line A-A in FIG. 2 showing the head inclining 25° with respect to the handle;

FIG. 11 illustrates the head rotating at multiple angles; and

FIG. 12 illustrates a different pattern formed on the pull button.

### DETAILED DESCRIPTION OF THE INVENTION

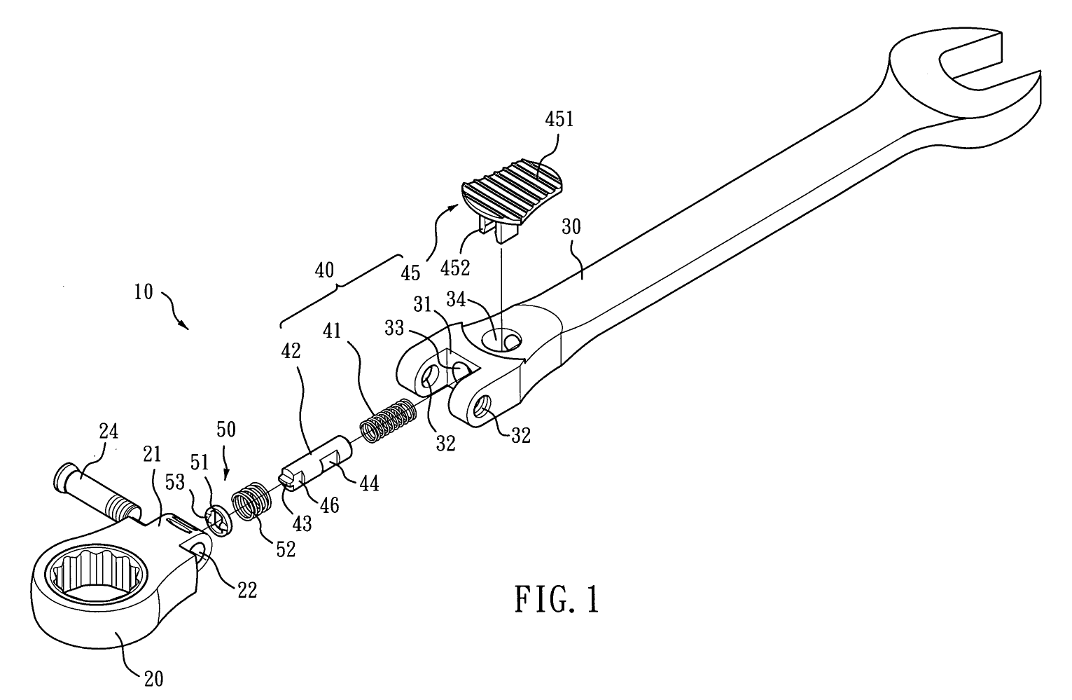

FIG. 1 illustrates an exploded view of a handle tool having an adjustable head with joint lock mechanism according to the present invention. A wrench 10 comprises a head 20, a handle 30 and a joint lock mechanism 40. A convex portion 21 is formed at a rear end of the head 20 and a through hole 22 is formed through the convex portion 21. A concave portion 31 is formed at a front end of the handle 30 and two through apertures 32 are formed at opposite sides thereof where one of the through apertures 32 is threaded to receive a screw 24 for pivotally coupling the head 20 to the handle 30. Regarding the configuration between the screw 24 and the two through holes 32, please refer to TW566274 for more details. A first aperture 33 is formed at the front end of the handle 30 and substantially extends along the length thereof, and a second aperture 34 is formed at one side of the handle 30 and perpendicularly intersects the first aperture 33.

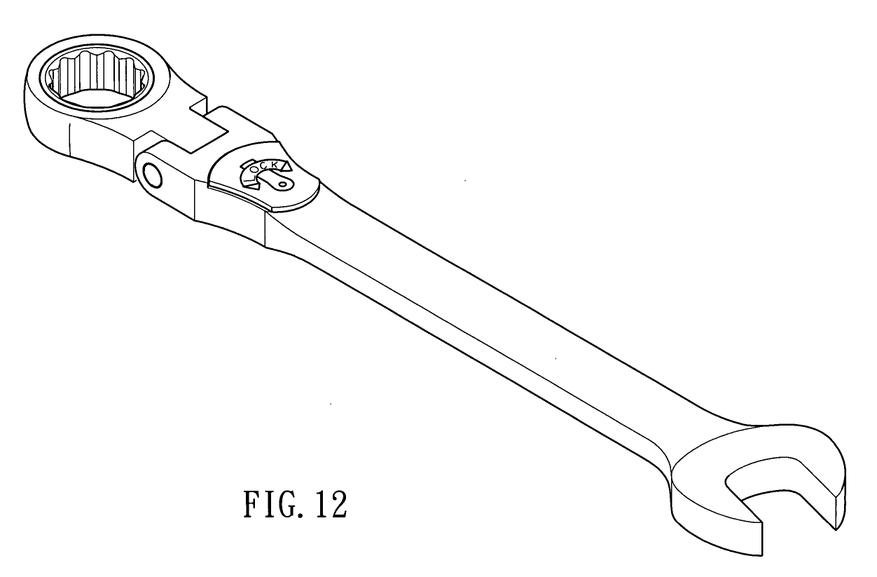

A joint lock mechanism 40 comprises a first engaging device disposed at the rear end of the head 20, a second engaging device received in the first aperture 33 formed at the front end of the handle 30, a first elastic device and a pull button 45 comprising a knob portion 451 and an engaging portion. Preferably, the first engaging device can be a plurality of slots 23 formed equidistantly along the surface of the convex portion 21 and the slots 23 preferably extend along the axis of the through hole 22. In general, the surface of the convex portion 21 can be an arc of 180°, or of any other suitable shape. In this preferred embodiment, nine slots are formed so that the angle between two adjacent slots is22.5°. Preferably, the second engaging device is a pin 42 and the first elastic device is a first spring 41. An engaging portion, which is a protrusion 43 of a substantially arc shape, is formed at a front end of the pin 42. As illustrated in FIG. 3, the first spring 41 is received at and abuts against a bottom end of the first aperture 33 and biases the pin 42 with a forward force such that the protrusion 43 of the pin 42 can be pushed to engage any of the slots 23. A pair of slots 44 is formed at the opposite sides of the pin 42 between the front and the rear ends of the pin 42. The engaging portion of the pull button 45 comprises two hooks 452 disposed beneath the knob portion 451 and extending along the second aperture 34 to engage the corresponding pair of slots 44 such that the pull button 45 can be pulled to actuate the pin 42 to move along the first aperture 33. The knob portion 451 can be of a shield design formed with a plurality of anti-slip teeth thereon or with a pattern consisting of a word “LOCK”, a side-view mark of the head and a double arrow crossing the side-view mark (referring to FIG. 12). Alternatively, the pin 42 can be formed with a through slot between the front and the rear ends thereof (not shown in figure) and the engaging portion of the pull button 45 can be a hook extending along the second aperture 34 to engage the through slot (not shown in figure) such that the pull button 45 can be pulled to actuate the pin 45 to move along the first aperture 33.

Preferably, the joint lock mechanism 40 can further comprise a positioning device 50 having a positioning element, preferably a positioning plate 51, and a second elastic device, preferably a second spring 52. The positioning plate 51 is received in a front portion 331 of the first aperture 33 having a larger diameter (referring to FIG. 3), which can be formed by reaming a stepped aperture at the front end of the first aperture 33, while a rear portion 332 thereof has a smaller diameter (referring to FIG. 3). A pair of slots 46 is disposed at the front end of the pin 42 and the positioning plate 51 is received in the slots 46. The positioning plate 51 has a shape substantially matching that of the protrusion 43 so as to guide the protrusion 43 to engage one of the plurality of slots 23. The second spring 52 is positioned behind the positioning plate 51 with its front end abutting against the positioning plate 51 with a forward force and its rear end abutting against a shoulder portion 333 formed between the front portion 331 and the rear portion 332, such that protrusions 53 of the positioning plate 51 and the protrusion 43 of the pin 42 can together engage one of the plurality of slots 23.

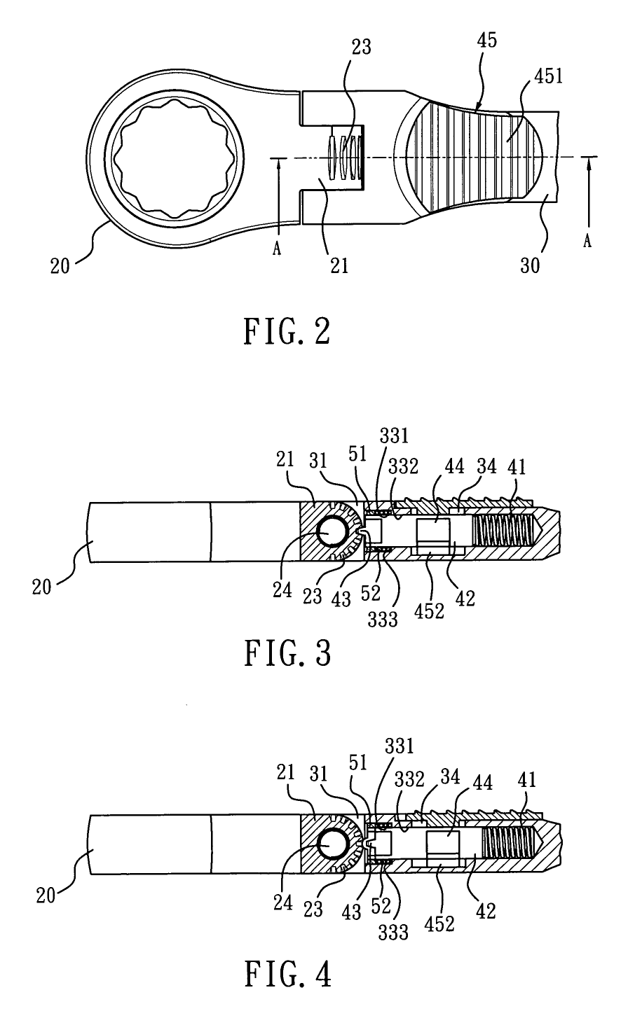

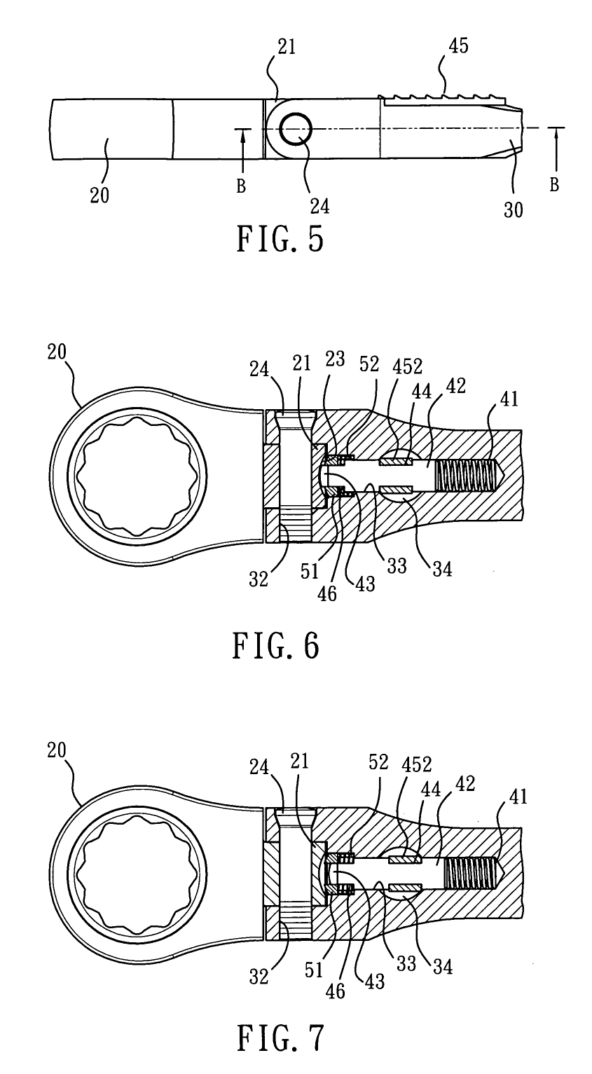

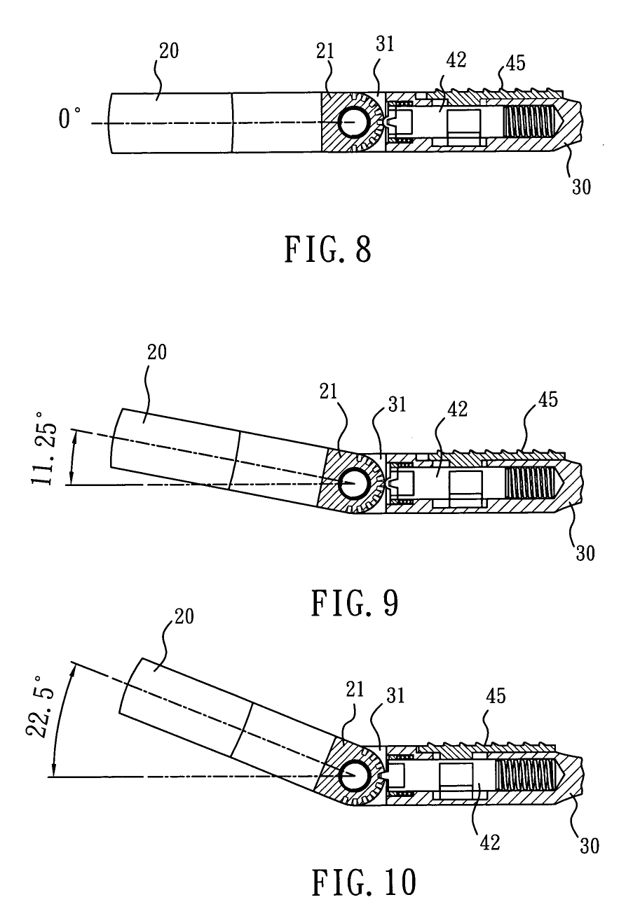

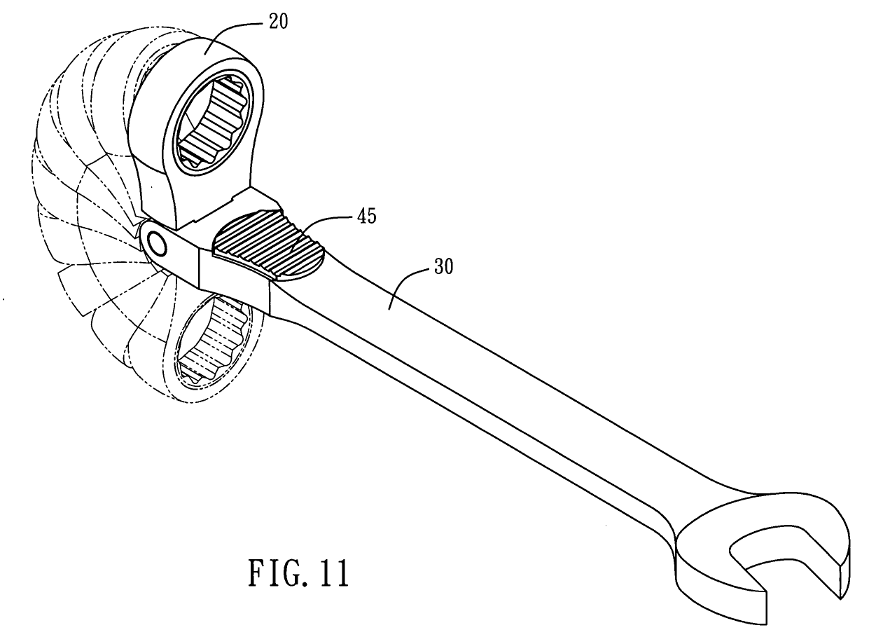

FIGS. 2 and 5 illustrate a locally enlarged plan view and a locally enlarged side view of the hand tool according to the present invention, respectively. From FIGS. 3 and 6, it can be seen that when the pull button 45 is at a locked state, each of the protrusion 43 of the pin 42 and the protrusions 53 of the positioning plate 51 can moveably engage one of the plurality of slots 23, whereas only the protrusions 53 of the positioning plate 51 can moveably engage one of the plurality of slots 23 when the pull button 45 is at an unlocked state. Therefore, when the pin 42 disengages the head 20 at the unlock state, the head 20 can pivotally rotate with respect to the handle 30 and also be prevented from rotating due to gravity. As illustrated in FIGS. 8 to 10, when an external force drives the head 20 to a certain angle, the head 20 can be bent and positioned to a predetermined angle. FIG. 11 illustrates the head rotating at multiple angles.

From the above descriptions, it is apparent that the present invention provides a hand tool having an adjustable head with joint lock mechanism and has easier and more secured positioning over the prior art. While the invention has been described in terms of several preferred embodiments, those skilled in the art will recognise that the invention can still be practiced with modifications, within the spirit and scope of the appended claims.

1. A hand tool having an adjustable head with joint lock mechanism, comprising:
a head having a rear end;
a handle having a front end pivotally coupled to the rear end of the head, the handle having a first aperture longitudinally extending at the front end thereof, and a second aperture formed perpendicularly intersecting the first aperture; and
the joint lock mechanism disposed between the rear end of the head and the front end of the handle, characterised in that:
the joint lock mechanism further comprises:
a first engaging device disposed at the rear end of the head;
a second engaging device received in the first aperture of the front end of the handle, the second engaging device having a front end and a rear end;
a pull button having a knob portion and an engaging portion beneath the knob portion, the engaging portion extending along the second aperture and engaging the second engaging device; and
a first elastic device received in the first aperture and abutting against the second engaging device with a forward force such that the front end of the second engaging device is pushed to engage the first engaging device.

2. The hand tool according to claim 1, further comprising a fastening device, wherein the rear end of the head has a convex pivotal portion and the front end of the handle has a concave pivotal portion pivoting on the convex pivotal portion, and wherein the fastening device is disposed through the convex pivotal portion and the concave pivotal portion thereby the fastening device is pivotally coupled to the convex pivotal portion while being fixedly coupled to the concave pivotal portion.

3. The hand tool according to claim 2, wherein the first engaging device has a plurality of slots formed equidistantly along the surface of the convex pivot portion, and the second engaging device has at least one engaging portion formed at the front end thereof to engage one of the plurality of slots such that the first engaging device is adapted to engage the second engaging device.

4. The hand tool according to claim 3, further comprising a positioning device which has a positioning element and a second elastic device, the positioning element disposed at the front end of the first aperture and having a shape substantially matching that of the at least one engaging portion at the front end of the second engaging device to guide the at least one engaging portion to engage one of the plurality of slots; the second elastic device positioned behind the positioning element and abutting against the positioning element with a forward force.

5. The hand tool according to claim 4, wherein the first aperture has a front portion having a larger diameter and a rear portion having a smaller diameter which forms a shoulder portion in between, and the second elastic device is disposed in the front portion with its front end abutting against the positioning device while its rear end abutting against the shoulder portion.

6. The hand tool according to claim 2, wherein the second engaging device include a pair of slots formed at opposite sides between the front and the rear ends thereof, and the engaging portion of the pull button comprises two hooks engaging the corresponding pair of slots such that the pull button is adapted to actuate the second engaging device to move along the first aperture.

7. The hand tool according to claim 2, wherein the second engaging portion has a through slot formed between the front and the rear ends thereof, and the engaging portion of the pull button is a hook engaging the through slot such that the pull button is adapted to actuate the second engaging device to move along the first aperture.

8. The hand tool according to claim 3, wherein the surface of the convex pivot portion is an arc.

9. The hand tool according to claim 1, wherein the knob portion has a surface formed with a plurality of anti-slip teeth.

10. The hand tool according to claim 1, wherein the knob portion has a surface formed with pattern consisting of a word “LOCK”, a side-view mark of the head and a double arrow crossing the side-view mark.
